(19) United States
(12) Patent Application Publication
(10) Pub. No.: US 2006/0167921 A1
(43) Pub. Date: Jul. 27, 2006

(54) System and method using a distributed lock manager for notification of status changes in cluster processes

(76) Inventors: Gary L. Grebus, Brookline, NH (US); Dan C. Vuong, Ayer, MA (US); Paul Moore, Bedford, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/999,521

(22) Filed: Nov. 29, 2004

(51) Int. Cl. G06F 17/00

(52) U.S. Cl. 707/102

(57) ABSTRACT

According to at least one embodiment, a method comprises implementing a distributed lock manager (DLM) within a cluster. The method further comprises using locks of the DLM to manage notification to at least one monitoring cluster process of a change in status of at least one monitored cluster process.

### FIELD OF THE INVENTION

The below description relates in general to management of clusters, and more specifically to systems and methods for providing notification of status changes of processes within a cluster.

### DESCRIPTION OF RELATED ART

In general, a cluster is a group of processor-based nodes (e.g., servers and/or other resources) that act like a single system. That is, clustering generally refers to communicatively connecting two or more computers together in such a way that they behave like a single computer. Clustering is used for parallel processing, load balancing, and/or fault tolerance (or “high availability”), as examples. Each node of a cluster may be referred to as a “member” of that cluster.

Clustering may be implemented, for example, using the TruCluster™ Server product available from Hewlett-Packard Company. Such TruCluster Server is described further in the manual for the TruCluster Server Version 5.1B dated September 2002 and titled “TruCluster Server: Cluster Highly Available Applications.” That manual describes generally how to make applications highly available on a Tru64 UNIX TruCluster Server Version 5.1B cluster and describes generally the application programming interface (API) libraries of the TruCluster Server product. The TruCluster Server product provides for a distributed lock manager (DLM) for synchronizing access by the cluster members to shared resources in the cluster, as described further in chapter 9 of the above-referenced manual. Various other techniques for implementing a cluster and DLMs are known in the art.

Traditionally, DLMs are implemented in clusters to provide functions that enable cooperating processes in a cluster to synchronize access to a shared resource, such as a raw disk device, a file, or a program. For the DLM to effectively synchronize access to a shared resource, all processes in the cluster that share the resource use DLM functions to control access to the resource. DLM functions may enable callers to perform such operations as request a new lock on a resource, and release a lock or group of locks, as examples.

In a clustered environment, a desire often exists for monitoring the status of cluster processes (e.g., cluster nodes and/or processes executing on such nodes) and notifying other processes (e.g., other nodes) within the cluster of changes in the status of the monitored processes. For example, if a new node (or process) is added to the cluster (or “birthed”), it may be desirable for existing members of the cluster to be notified of the existence of such new node (or process). As another example, if an existing cluster member (or process) ends/fails (or “dies”), the remaining members of the cluster may desire to also be notified of such event. Heartbeat messages are traditionally exchanged within a cluster for performing this type of monitoring and notification. More particularly, such techniques as active polling within the cluster, message exchange between member clusters, and/or monitoring of heartbeat messages for various nodes/processes of a cluster may be used for detecting and reporting status changes, such as node births and deaths, to cluster members.

Configuring such traditional techniques for monitoring processes within a cluster became undesirably complex and difficult to implement

### BRIEF SUMMARY OF THE INVENTION

According to at least one embodiment, a method comprises implementing a distributed lock manager (DLM) within a cluster. The method further comprises using locks of the DLM to manage notification to at least one monitoring cluster process of a change in status of at least one monitored cluster process.

According to at least one embodiment, a method comprises implementing a DLM within a cluster, wherein the DLM provides locking facilities usable by cluster members to lock resources. The method further comprises using locking facilities of the DLM to implement a transparent state machine for notifying cluster members of a status change of at least one process within the cluster.

According to at least one embodiment, a system comprises a cluster having a plurality of processor-based devices as members. The system further comprises a DLM implemented within the cluster, wherein the members use the DLM at least in part for receiving notification of a status change in at least one monitored cluster process.

### BRIEF DESCRIPTION OF THE DRAWINGS

FIGS. 1A-1B show an example cluster adapted in accordance with at least one embodiment for using DLM for providing notification of a status change in a cluster process;

FIG. 2 shows an example implementation wherein the DLM provides blocking and completion notifications;

FIG. 3 shows an example operational flow according to at least one embodiment for reporting a status change in a monitored cluster process to a monitoring cluster process;

FIGS. 4A-4B show a more detailed operational flow according to one embodiment for notifying existing cluster processes of the birth of a new monitored process within the cluster; and

FIG. 5 shows a detailed operational flow according to one embodiment for notifying existing cluster processes of the death of monitored process within the cluster.

### DETAILED DESCRIPTION

Various embodiments described herein use a DLM to detect and report status changes in monitored cluster processes to monitoring processes within the cluster. In certain embodiments, a monitored process is also a monitoring process. For instance, a given member of a multi-member cluster may monitor all other members, and every other member may likewise monitor the given member. As described further below, in certain embodiments, blocking notifications and completion notifications provided by the DLM are leveraged for use in notifying monitoring processes of status changes in monitored processes. Thus, embodiments described herein leverage the locking facilities of a cluster's DLM for managing detection and notification of status changes in monitored cluster processes, rather than requiring implementation of a separate mechanism for such management. Accordingly, the DLM is leveraged such that a separate communication protocol, data structures, etc. are not necessary for managing the detection and notification of status changes in monitored cluster processes.

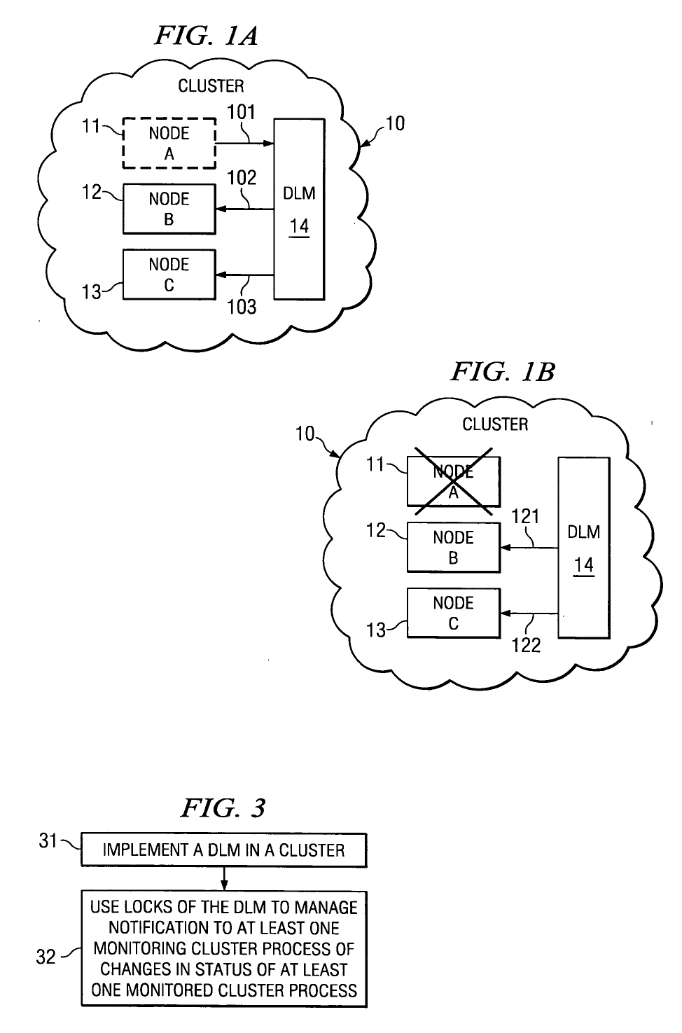

FIGS. 1A-1B show an example cluster adapted in accordance with at least one embodiment for using DLM for providing notification of a status change in a cluster process. More particularly, FIG. 1A shows an example in which a new node (Node A) is birthed within a cluster, and the DLM is used for reporting such birth of the new node to existing cluster members (Nodes B and C). FIG. 1B shows an example in which an existing cluster member (Node A) dies, and the DLM is used for reporting such death to the remaining cluster members (Nodes B and C).

Turning first to the example of FIG. 1A, a cluster 10 includes various existing members, such as Member B (labeled 12) and Member C (labeled 13). As described further herein, cluster 10 implements DLM 14. It should be understood that while shown as a separate component for ease of illustration in FIG. 1A, implementation of DLM 14 may actually be distributed among the cluster members. In certain implementations, DLM 14 is used for synchronizing access to shared resources. For instance, DLM 14 may provide functions that facilitate cooperating processes in cluster 10 to synchronize access to a shared resource, such as a raw disk device, a file, or a program, as examples. Further, in accordance with various embodiments described further herein, DLM 14 is used to report a status change in a monitored process to one or more monitoring processes within cluster 10. For instance, in the example of FIG. 1A, a new node, Node A (labeled 11), is birthed in cluster 10, and DLM 14 is used to report the birth of such new node to the existing cluster members B and C.

In accordance with one embodiment, upon Node A 11 attempting to join cluster 10, it requests, via request 101, a state change to a lock of DLM 14, which triggers notification of the requested state change to members B 12 and C 13, via notifications 102 and 103, respectively. More particularly, in one embodiment monitoring members B 12 and C 13 set locks associated with Node A 11 and request blocking notification for those locks. Then, upon Node A 11 being birthed it attempts to set an incompatible lock (via request 101), which triggers blocking notification to members B 12 and C 13, thus effectively notifying them of the birth of node A 11. Accordingly, notifications 102 and 103 effectively report the birthing of the new node A 11 within cluster 10 to the monitoring members B 12 and C 13. Example techniques for implementing DLM 14 to trigger such notifications of the birth of a new node within the cluster are described further below.

In the example of FIG. 1B, cluster 10 includes existing members A (labeled 11), B (labeled 12), and C (labeled 13) (e.g., cluster 10 of FIG. 1A after the birthing of Node A). Again, cluster 10 implements DLM 14. In the example of FIG. 1B, member A 11 fails (dies), and DLM 14 is used to report the death of member A 11 to the remaining cluster members B 12 and C 13. In accordance with one embodiment, members B 12 and C 13 have pending state changes to a lock associated with member A 11, which are not permitted to be completed as long as member A 11 is a live member of cluster 10. Further, members B 12 and C 13 register a request with DLM 14 for notification of the completion of the pending state changes. Thus, upon the death of member A 11 the pending state changes are allowed to complete, which triggers notification of their completion to members B 12 and C 13, via notifications 121 and 122, respectively. Accordingly, notifications 121 and 122 effectively report the death of the member A 11 to the monitoring members B 12 and C 13. Example techniques for implementing DLM 14 to trigger such notifications of the death of an existing cluster member are described further below.

While shown in FIGS. 1A and 1B as notifying of a node birth or node death within a cluster, embodiments provided herein are not limited in application to status changes of the nodes, but may be used additionally or alternatively for notification of status changes of processes executing on the nodes. As used herein, a status change to a “process” (or “cluster process”) is intended to encompass a status change (e.g., birth or death) of a node itself, as well as a status change to a process executing on a node, unless accompanying language specifies otherwise (e.g., the language “a process on a node” refers specifically to a process on a node). Thus, reference to a status change in a process may refer to either a status change of a node (e.g., the birth or death of a node) or a status change of a process executing on a node (e.g., birth or death of a process executing on a node), unless accompanying language specifies one or the other.

Co-pending and commonly assigned U.S. Provisional Patent Application Ser. No. 60/585,476 filed Jul. 2, 2004, entitled “SYSTEM AND METHOD FOR SUPPORTING SECURED COMMUNICATION BY AN ALIASED CLUSTER,” the disclosure of which is hereby incorporated herein by reference, provides an example cluster in which embodiments described herein may be used for notifying cluster members about the status of processes executing on member nodes of the cluster. For instance, embodiments described further herein may be implemented within a cluster of the above co-pending patent application to notify cluster members of changes in the status of the IKE daemon processes executing on the cluster members in such co-pending provisional patent application.

As mentioned above, various techniques for implementing DLMs are known, and such DLMs are typically implemented in clusters for use in synchronizing access by cluster processes to shared resources. In general, any DLM that has notification capabilities as described further herein may be used in implementing the embodiments for notifying cluster processes (e.g., cluster members) of status changes in monitored cluster processes. The TruCluster™ Server product available from Hewlett-Packard Company provides an implementation of a DLM for a cluster, as described further in chapter 9 of the manual for the TruCluster Server Version 5.1B dated September 2002 and titled “TruCluster Server: Cluster Highly Available Applications.” The DLM of such TruCluster Server is briefly described in Appendix A of this specification, the disclosure of which is incorporated herein by reference, as a concrete example of a DLM, but again the embodiments described herein are not limited in application to the specific example DLM implementation described in Appendix A.

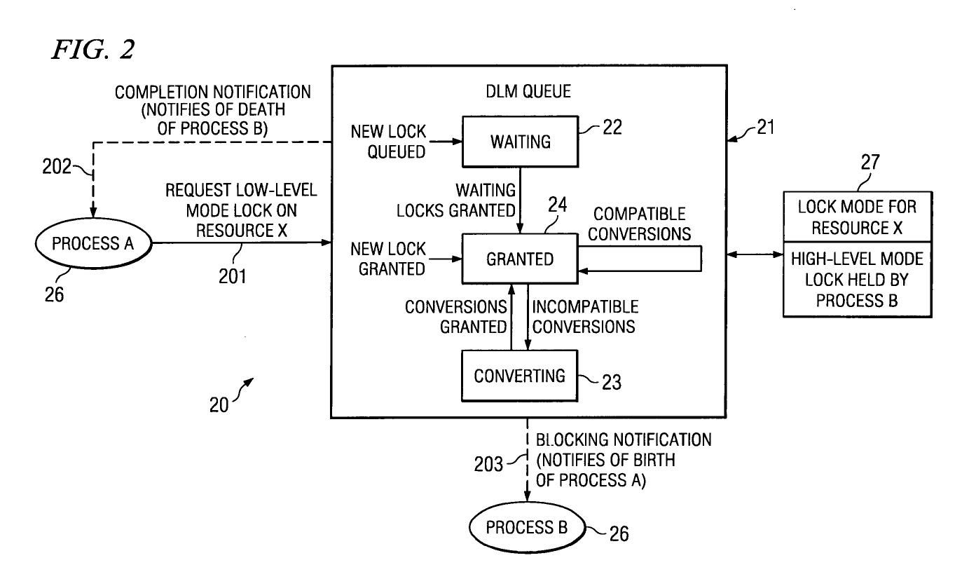

Turning to FIG. 2, an example implementation is shown wherein the DLM provides blocking and completion notifications, which are used in accordance with certain embodiments for notifying monitoring cluster processes of a status change in a monitored cluster process. More particularly, FIG. 2 shows an example cluster 20 that includes a DLM, such as DLM 14 of FIGS. 1A-1B, having a DLM queue 21. As in the example TruCluster DLM described above, a lock on a resource can be in one of the following three states: 1) WAITING 22, 2) CONVERTING 23, or GRANTED 24. In this example, a cluster process B 26 holds a high-level mode lock 27 on resource X, and has registered blocking notification for that lock with the DLM. That is, cluster process B 26 is to be notified in the event that its high-level mode lock 27 on resource X is blocking a pending lock from completing. Further, in this example, cluster process A 25 makes a request 201 for a low-level mode lock on resource X. This low-level mode lock requested by cluster process A 25 is incompatible with and is thus blocked by the higher-level mode lock 27 held by cluster process B 26. This triggers blocking notification 203 to cluster process B 26. As described further below, certain embodiments use this technique to notify existing cluster processes (e.g., members) of the birthing (or addition) of a new process within the cluster. For instance, suppose that as process A 25 is birthed, it makes request 201 to set a low-level mode lock on a given resource (resource X in this example). Accordingly, upon receiving blocking notification 203, process B 26 is effectively notified of the birthing of the new process A 25.

As further shown in the example of FIG. 2, processes can register a completion notification with the DLM so that the process is notified of completion of a requested lock. For instance, if process B 26 releases its higher-level mode lock 27 on resource X, then the lower-level mode lock requested by process A 25 is allowed to complete, and process A 25 is provided completion notification 202 notifying it that its requested lock has been completed on resource X. As described further below, certain embodiments use this technique to notify existing cluster processes (e.g., members) of the death of another cluster process. For instance, suppose that process B 26 maintains its high-level mode lock 27 on resource X as long as it is alive in the cluster. In this instance, upon receiving completion notification 202, process A 25 is effectively notified of the death of process B 26.

Accordingly, as described further herein, certain embodiments utilize the blocking and completion notifications of the DLM to provide notification to one or more monitoring processes of a status change in a monitored process. Thus, in certain embodiments, the DLM is used not only for synchronizing access to shared resources within a cluster, but is also leveraged to effectively implement a state machine for notifying monitoring process(es) of status changes in a monitored process. In this regard, the DLM of certain embodiments may be considered a transparent state machine, as specific protocols, additional data structures, etc. are not required for its implementation for notifying monitoring process(es) of status changes in a monitored process. Rather, the existing functions of the DLM are leveraged in a manner for detecting status changes in monitored processes and notify the monitoring process(es) of such status changes.

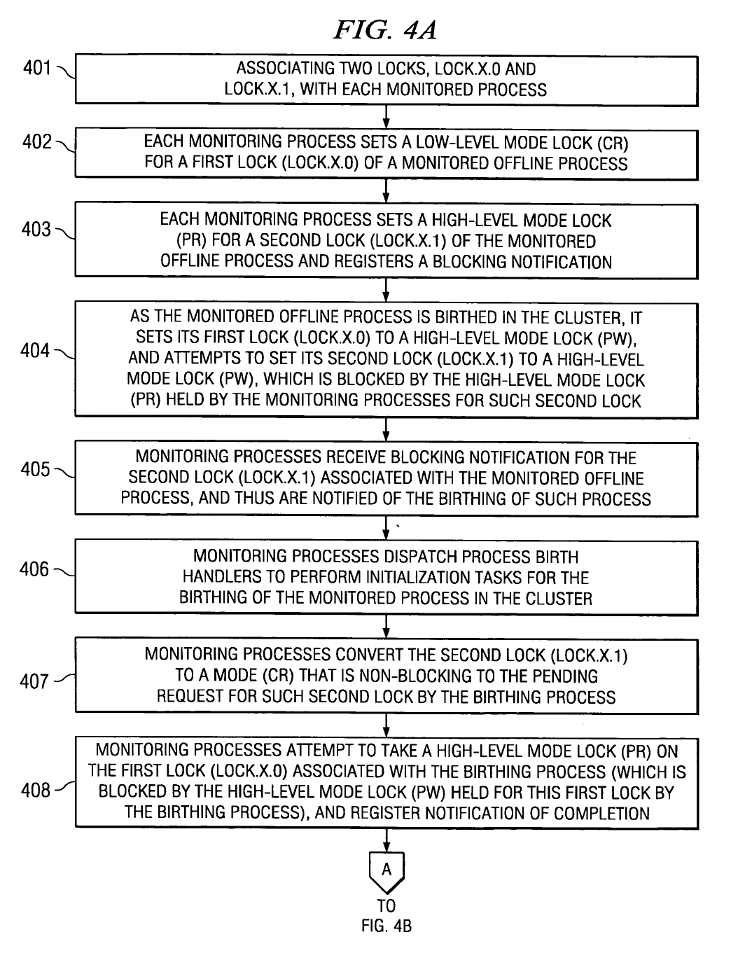

Turning to FIG. 3, an example operational flow according to at least one embodiment for reporting a status change in a monitored cluster process to a monitoring cluster process is shown. In operational block 31, a DLM is implemented within a cluster. As described above, in certain implementations the DLM may be used for synchronizing access to shared resources. Further, in operational block 32, the locks of the DLM are used to manage notification to at least one monitoring cluster process of a change in status of at least one monitored cluster process.

According to one embodiment, two types of status changes in a monitored cluster process are detected and reported to monitoring cluster process(es): 1) the startup (“birth”) of a new instance of a monitored cluster process, and 2) the termination (“death”) of an existing monitored cluster process. In this example embodiment, both an orderly shutdown and a crash (or failure) of the monitored cluster process are considered as a death of the process that is detected and reported to the monitoring cluster process(es). In this example embodiment, the same mechanism is relied upon to provide notification of birth and death events, and such notification mechanism includes two DLM locks per monitored cluster process, LOCK.X.0 and LOCK.X.1, where X is an identifier (ID) for a given monitored cluster process. Each monitoring cluster process holds a lock for each monitored cluster process ID, and use DLM notifications to detect birth and death events for the monitored cluster processes.

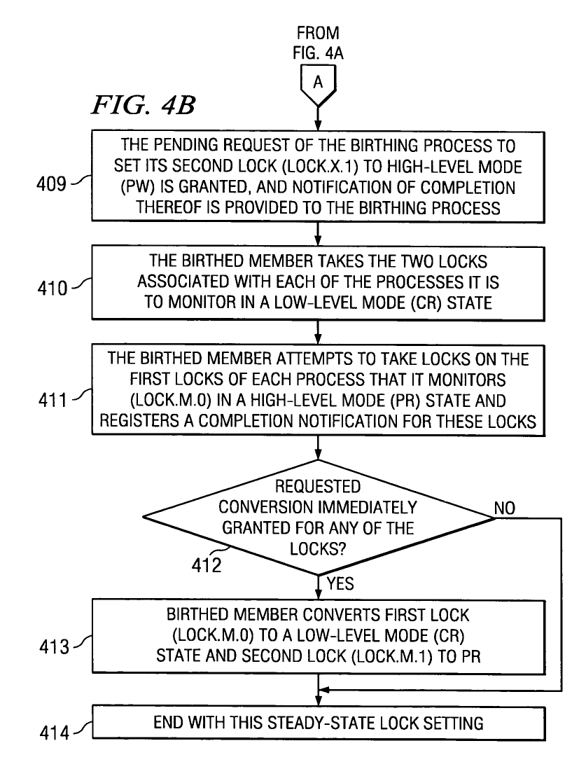

FIGS. 4A-4B show a more detailed operational flow according to one embodiment for notifying existing cluster processes of the birth of a new monitored process within the cluster. More particularly, in this example, existing cluster members are notified of the birth of a new member in the cluster. The flow of FIGS. 4A-4B is described in connection with a specific example of birthing a new node A within a cluster having existing members B and C, as in the example of FIG. 1A.

In operational block 401 (FIG. 4A), two locks (LOCK.X.0 and LOCK.X.1) are associated with each monitored process in the cluster. Accordingly, in this accompanying example in which node A is starting to come online within a cluster (i.e., is being birthed) while nodes B and C are already online (i.e., already members of the cluster), two locks are provided for each of the possible node IDs. That is, locks LOCK.A.0 and LOCK.A.1 are associated with node A; locks LOCK.B.0 and LOCK.B.1 are associated with node B; and locks LOCK.C.0 and LOCK.C.1 are associated with node C. Each cluster member holds a lock for each possible member ID. In general, the DLM notifications (particularly the blocking notifications) are used for the LOCK.X.1 to report birthing of the X process within the cluster, and the DLM notifications (particularly the completion notifications) are used for the LOCK.X.0 to report the death of the X cluster process.

The state of the locks before node A comes online is shown in Table 4, wherein the following notation is used:
CR—Lock held in Concurrent Read.
PR—Lock held in Protected Read.
PW—Lock held in Protected Write.

CR->PR—Lock held in Concurrent Read with a conversion request to Protected Read enqueued.

TABLE 4

| | LOCK.A.0 | LOCK.A.1 | LOCK.B.0 | LOCK.B.1 | LOCK.C.0 | LOCK.C.1 |
|---|---|---|---|---|---|---|
| Node A | | | | | | |
| Node B | CR | PR | PW | PW | CR->PR | CR |
| Node C | CR | PR | CR->PR | CR | PW | PW |

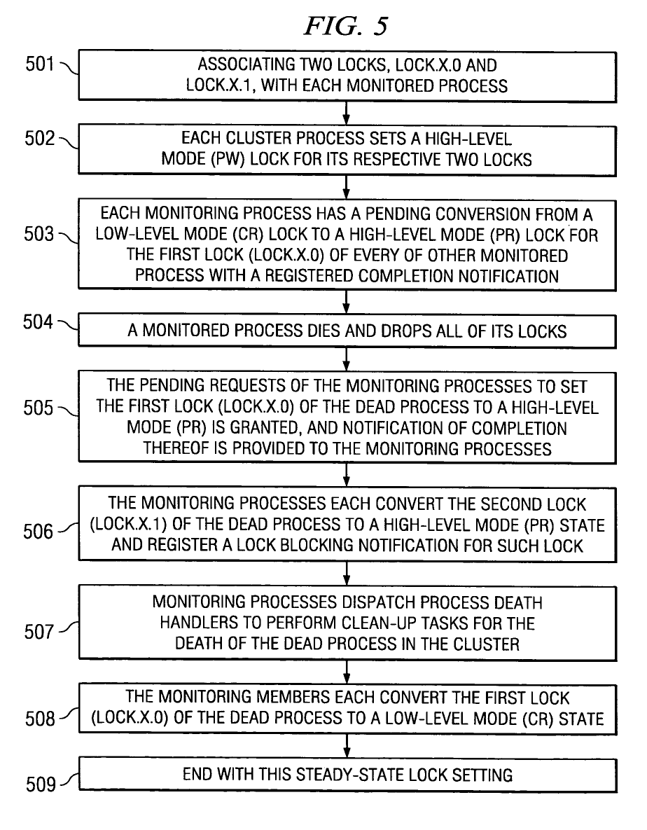

Thus, in this steady state of the cluster, its existing members B and C each hold a Protected Write (PW) mode lock for their respective locks. That is, member B holds a PW mode lock for its respective locks LOCK.B.0 and LOCK.B.1, and member C holds a PW mode lock for its respective locks LOCK.C.0 and LOCK.C.1. As described above, a PW mode lock is a higher-level mode lock than CW, PR, and CR mode locks. As further shown in Table 4, member B holds a Concurrent Read (CR) mode lock for the LOCK.C.1 lock associated with member C, and member C holds a CR mode lock for the LOCK.B.1 lock associated with member B. Additionally, member B has a pending conversion requested from CR to PR for LOCK.C.0, and member C has a pending conversion requested from CR to PR for LOCK.B.0. As described further in connection with the example flow of FIG. 5 below, the PW lock held by member B for its LOCK.B.0 lock is incompatible with and blocks the pending conversion requested by member C for converting LOCK.B.0 from CR to PR. That is, the PR mode lock requested by member C is blocked by the PW mode lock held by member B. Thus, as long as member B holds the PW mode lock, the conversion to PR mode lock requested by member C for LOCK.B.0 is not allowed to complete. The same holds true for the pending conversion requested by member B for converting LOCK.C.0 from CR to PR, which is blocked by member C's PW mode lock held for its LOCK.C.0 lock.

In operational block 402 of FIG. 4A, each monitoring process sets a low-level mode lock (e.g., CR) for a first lock (LOCK.X.0) of a monitored offline process. For instance, as also shown in Table 4, members B and C each hold LOCK.A.0 in a Concurrent Read (CR) mode. In operational block 403, each monitoring process sets a high-level mode lock (e.g., PR) for a second lock (LOCK.X.1) of the monitored offline process and registers a blocking notification for such lock. For instance, in the accompanying example of Table 4, members B and C each hold LOCK.A.1 in a protective read (PR) mode. As described further below, the DLM blocking notifications for the LOCK.A.1 lock are used in this embodiment for notifying members B and C of the birthing of node A.

In operational block 404, as the monitored offline process is birthed in the cluster, it sets its first lock (LOCK.X.0) to a high-level mode lock (e.g., PW), and attempts to set its second lock (LOCK.X.1) to a high-level mode lock (e.g., PW), which is blocked by the high-level mode lock (e.g., PR) held by the monitoring processes for such second lock. In the accompanying example, as node A is coming online within the cluster, it takes LOCK.A.0 in a protected write state, and node A attempts to take LOCK.A.1 in a protected write state and registers a completion notification for the lock. Accordingly, the state of the locks become as shown in Table 5 below.

TABLE 5

| | LOCK.A.0 | LOCK.A.1 | LOCK.B.0 | LOCK.B.1 | LOCK.C.0 | LOCK.C.1 |
|---|---|---|---|---|---|---|
| Node A | PW | NL->PW | | | | |
| Node B | CR | PR | PW | PW | CR->PR | CR |
| Node C | CR | PR | CR->PR | CR | PW | PW |

In operational block 405, the monitoring processes receive blocking notification for the second lock (LOCK.X.1) associated with the monitored offline process, and thus are notified of the birthing of such process. For instance, in the accompanying example, existing members B and C each receives a lock blocking notification on LOCK.A.1. That is, the Protected Read (PR) locks held by members B and C block the pending Protected Write (PW) requested by node A for such LOCK.A.1. In this example, members B and C each registered blocking notifications for their PR locks set for the LOCK.A.1 lock, and thus they each receive the blocking notification, which effectively notifies them of the birthing of node A. For instance, in this example embodiment, the locks LOCK.X.0 and LOCK.X.1 are dedicated for use in notifying of status changes in node X. Thus, the only process that would be requesting to take a PW lock for LOCK.A.1 is process (or node) A. Therefore, upon receiving blocking notification for such LOCK.A.1, members B and C are able to assume that node A is being birthed.

In operational block 406, the monitoring processes dispatch birth handlers to perform initialization tasks for the birthing of the monitored process in the cluster. For instance, in the accompanying example, members B and C each dispatch any Node-Birth handlers that are registered. These Node-Birth handlers are used to perform any initialization tasks associated with birthing a new node within the cluster, such as notifying other sub-systems in the cluster that a new node is coming online.

After completion of the dispatched birth handlers, the monitoring processes convert, in operational block 407, the second lock (LOCK.X.1) associated with the birthed process to a mode (e.g., CR) that is non-blocking to the pending request for such second lock by the birthing process. Thus, the pending request of the birthing process to set its second lock (LOCK.X.1) to a high-level mode (e.g., PW) is granted, and notification of completion thereof is reported to the birthing process. Additionally, the monitoring processes attempt to take a high-level mode lock (e.g., PR) on the first lock (LOCK.X.0) associated with the birthing process (which is blocked by the high-level mode lock (e.g., PW) held for this first lock by the birthing process), and register notification of completion, in operational block 408. And, in block 409 (FIG. 4B) the pending request of the birthing process to set its second lock (LOCK.X.1) to high-level mode (PW) is granted, and notification of completion thereof is provided to the birthing process.

For instance, in the accompanying example, after the Node-Birth handlers run to completion, members B and C each convert LOCK.A.1 to a Concurrent Read (CR) state, and members B and C each attempt to take LOCK.A.0 in a Protected Read (PR) state and register a completion notification for the lock. Because the LOCK.A.1 lock modes held by members B and C are changed to Concurrent Read (CR) states, the pending request by node A for taking a Protected Write (PW) mode lock on LOCK.A.1 is no longer blocked and is thus permitted to complete. Thus, the conversion request to PW for LOCK.A.1 by node A is granted and the completion callback is provided to Node A. Further, the requests by members B and C for taking LOCK.A.0 in a Protected Read (PR) state is blocked by the higher-level mode (PW) state held by node A. As described further in connection with the example flow of FIG. 5 below, the PW lock held by member A for its LOCK.A.0 lock is incompatible with and blocks the pending conversion requested by members B and C for converting LOCK.A.0 from CR to PR. That is, the PR mode lock requested by members B and C is blocked by the PW mode lock held by member A. Thus, as long as member A holds the PW mode lock, the conversion to PR mode lock requested by members B and C for LOCK.A.0 is not allowed to complete.

Table 6 shows the lock states with members B and C online and aware that Node A is also online within the cluster:

TABLE 6

| | LOCK.A.0 | LOCK.A.1 | LOCK.B.0 | LOCK.B.1 | LOCK.C.0 | LOCK.C.1 |
|---|---|---|---|---|---|---|
| Node A | PW | PW | | | | |
| Node B | CR->PR | CR | PW | PW | CR->PR | CR |
| Node C | CR->PR | CR | CR->PR | CR | PW | PW |

In certain embodiments, the birthed member A is not only a monitored member that is monitored by members B and C, but it is also a monitoring member that monitors the status of the other members (B and C) of the cluster. Thus, in this example, each member of the cluster monitors the status of every other member of the cluster via the DLM locks that are associated with each member. Thus, in operational block 410, the birthed member takes the two locks associated with each of the processes it is to monitor in a low-level mode (e.g., CR) state. Accordingly, in the accompanying example, member A takes LOCK.B.0 and LOCK.B.1 in a concurrent read state, and member A takes LOCK.C.0 and LOCK.C.1 in a concurrent read state.

In operational block 411, the birthed member attempts to take locks on the first locks of each process that it monitors (LOCK.M.0) in a high-level mode (e.g., PR) state and registers a completion notification for these locks. For instance, in the accompanying example, member A then attempts to take locks LOCK.B.0 and LOCK.C.0 in a Protected Read (PR) state and registers a completion notification for these locks.

In operational block 412, the birthed process determines whether the requested conversion is immediately granted for any of the locks. If the requested conversion is immediately granted for any of the locks of the process(es) that it monitors, then the corresponding process/node is dead. Accordingly, if the conversion is granted immediately for any of the locks, then operation advances to block 413 whereat the birthed process converts the first lock (LOCK.M.0) of such monitored process to a low-level mode (e.g. CR) state and the second lock (LOCK.M.1) of such monitored process to a PR state. Thus, in the accompanying example, member A converts the LOCK.M.0 lock for the dead nodes, if any, to Concurrent Read (CR) state. In this accompanying example, members B and C are each alive within the cluster, and therefore the request by member A for taking locks LOCK.B.0 and LOCK.C.0 in a Protected Read (PR) state is blocked by the higher-level mode (PW) state held by members B and C, respectively. As described further in connection with the example flow of FIG. 5 below, the PW lock held by members B and C for their respective locks LOCK.B.0 and LOCK.C.0 is incompatible with and blocks the pending conversion requested by member A for converting locks LOCK.B.0 and LOCK.C.0 from CR to PR. That is, the PR mode lock requested by member A is blocked by the PW mode lock held by members B and C for locks LOCK.B.0 and LOCK.C.0, respectively. Thus, as long as member B holds the PW mode lock for LOCK.B.0, the conversion to PR mode lock requested by member A for such lock LOCK.B.0 is not allowed to complete; and as long as member C holds the PW mode lock for LOCK.C.0, the conversion to PR mode lock requested by member A for such lock LOCK.C.0 is not allowed to complete.

The birthing process ends with the resulting steady state of the locks in operational block 414. Table 7 shows the lock states for the accompanying example where members A, B, and C are online and aware of each other, which is now the steady state for the cluster:

TABLE 7

| | LOCK.A.0 | LOCK.A.1 | LOCK.B.0 | LOCK.B.1 | LOCK.C.0 | LOCK.C.1 |
|---|---|---|---|---|---|---|
| Node A | PW | PW | CR->PR | CR | CR->PR | CR |
| Node B | CR->PR | CR | PW | PW | CR->PR | CR |
| Node C | CR->PR | CR | CR->PR | CR | PW | PW |

Thus, as described further below with the example flow of FIG. 5, each member is monitoring every other member for a change in status (e.g., death). Turning to FIG. 5, a detailed operational flow according to one embodiment for notifying existing cluster processes of the death of monitored process within the cluster is shown. As with FIGS. 4A-B above, the flow of FIG. 5 is described in connection with a specific example scenario in which a cluster has members A, B, and C, and node A dies, as in the example of FIG. 1B. Accordingly, in this case, member A is terminated (e.g., fails, is shutdown, etc.), and DLM is used to notify the remaining members B and C of member A's death. In operational block 501, two locks are associated with each monitored process (such as the two locks LOCK.X.0 and LOCK.X.1 described above with FIGS. 4A-B). In the accompanying example, the two locks LOCK.X.0 and LOCK.X.1 are again provided for each member ID (X).

In operational block 502, each cluster process sets a high-level mode (e.g., PW) lock for its respective two locks. The initial lock state in the accompanying example is as shown in Table 7 above, which is the steady state for this cluster having members A, B, and C. Thus, in this steady state of the cluster, its existing members A, B and C each hold a Protected Write (PW) mode lock for their respective locks. That is, member A holds a PW mode lock for its respective locks LOCK.A.0 and LOCK.A.1; member B holds a PW mode lock for its respective locks LOCK.B.0 and LOCK.B.1; and member C holds a PW mode lock for its respective locks LOCK.C.0 and LOCK.C.1. As described above, a PW mode lock is a higher-level mode lock than CW, PR, and CR mode locks. As further shown in Table 7, each member holds a Concurrent Read (CR) mode lock for the second lock (LOCK.X.1) associated with each other member. That is, member A holds a CR mode lock for the LOCK.B.1 and LOCK.C.1 locks associated with members B and C, respectively; member B holds a CR mode lock for the LOCK.A.1 and LOCK.C.1 locks associated with members A and C, respectively; and member C holds a CR mode lock for the LOCK.A.1 and LOCK.B.1 locks associated with members A and B, respectively.

Further, in operational block 503, each monitoring process has a pending conversion from a low-level mode (e.g., CR) lock to a high-level mode (e.g., PR) lock, with a registered completion notification, for the first lock (LOCK.X.0) of every other monitored process. This pending conversion is blocked by the high-level mode (e.g., PW) lock held by the process to which the first lock (LOCK.X.0) corresponds. In the accompanying example, each member has a pending conversion requested from CR to PR for the first lock (LOCK.X.0) associated with each other member. That is, as shown in Table 7, member A has a pending conversion requested from CR to PR for LOCK.B.0 and LOCK.C.0 associated with members B and C, respectively; member B has a pending conversion requested from CR to PR for LOCK.A.0 and LOCK.C.0 associated with members A and C, respectively; and member C has a pending conversion requested from CR to PR for LOCK.A.0 and LOCK.B.0 associated with members A and B, respectively. As described further below, the PW lock held by each member in its respective first lock (LOCK.X.0) is incompatible with and blocks the pending conversion from CR to PR for such first lock requested by the other members of the cluster.

In operational block 504, a monitored process dies and drops all of its locks. For instance, in the accompanying example, upon node A terminating, it drops all of its locks, resulting in the lock states shown in Table 8 below.

TABLE 8

| | LOCK.A.0 | LOCK.A.1 | LOCK.B.0 | LOCK.B.1 | LOCK.C.0 | LOCK.C.1 |
|---|---|---|---|---|---|---|
| Node A | | | | | | |
| Node B | CR->PR | CR | PW | PW | CR->PR | CR |
| Node C | CR->PR | CR | CR->PR | CR | PW | PW |

Therefore, in operational block 505, the pending requests of the monitoring processes to set the first lock (LOCK.X.0) of the dead process to a high-level mode (PR) is granted, and notification of completion thereof is provided to the monitoring processes. For instance, in the accompanying example, when node A dies and drops its locks, the pending conversion requests of members B and C from CR to PR for LOCK.A.0 are no longer blocked and are thus granted. Accordingly, completion notification of this pending conversion of LOCK.A.0 from CR to PR is provided to members B and C, thereby effectively notifying them of the death of member A. For instance, in this example embodiment, the locks LOCK.X.0 and LOCK.X.1 are dedicated for use in notifying of status changes in node X. Further, in this example, each member holds its respective first lock (LOCK.X.0) in PW mode as long as such member is alive within the cluster. Thus, the only situation in which the requested conversion of member A's LOCK.A.0 lock from CR to PR, by members B and C, is permitted is if member A dies. Therefore, upon receiving completion notification for such conversion of LOCK.A.0 from CR to PR, members B and C are able to assume that node A is dead.

In operational block 506, the monitoring processes each convert the second lock (LOCK.X.1) of the dead process to a high-level mode (e.g., PR) state and register a lock blocking notification for such lock. For instance, in the accompanying example, members B and C each convert LOCK.A.1 to a Protected Read (PR) state and register a lock blocking notification for such LOCK.A.1 lock of node A. As described above with the example provided in connection with the flow of FIGS. 4A-B, such blocking notification for LOCK.A.1 is used for notifying members B and C in the event that node A is birthed in the cluster. Therefore, if node A returns (i.e., is re-birthed) online within the cluster, the process described above with FIGS. 4A-B is followed and members B and C are notified of the return of node A.

In operational block 507, the monitoring processes dispatch process death handlers to perform clean-up tasks for the death of the dead process in the cluster. For instance, in the accompanying example, members B and C each dispatches any Node-Death handlers that are registered. These Node-Death handlers are used to perform any clean-up tasks associated with the death of node A within the cluster, such as notifying other sub-systems in the cluster that node A has gone offline.

After completion of the process death handlers, the monitoring members each convert the first lock (LOCK.X.0) of the dead process to a low-level mode (CR) state, in operational block 508. After the Node-Death handlers run to completion, members B and C each convert LOCK.A.0 to a concurrent read state. The process ends with the resulting steady state of the locks in operational block 509.

Table 9 shows the resulting lock state for the accompanying example where node A is now offline and members B and C are online:

TABLE 9

| | LOCK.A.0 | LOCK.A.1 | LOCK.B.0 | LOCK.B.1 | LOCK.C.0 | LOCK.C.1 |
|---|---|---|---|---|---|---|
| Node A | | | | | | |
| Node B | CR | PR | PW | PW | CR->PR | CR |
| Node C | CR | PR | CR->PR | CR | PW | PW |

Thus, the lock states for the cluster having remaining members B and C returns to the steady state shown in Table 9 where each existing member is monitoring every other existing member for a change in status (e.g., death). Further, this steady state of Table 9 corresponds to the steady state described above in Table 4. Accordingly, if node A is back online (is birthed) in the cluster, the existing members B and C are notified of such birthing of node A in the manner described above in connection with the flow of FIGS. 4A-B.

Various embodiments described above may be used for managing detection and notification of status changes in cluster nodes and/or specific processes executing on cluster nodes. For example, in certain embodiments, locks Lock.X.0 and Lock.X.1 may be associated with a cluster node X (and used as described above for detecting and notifying monitoring processes of changes in node X's status); and locks Lock.X₁.0 and Lock.X₁.1 may be associated with a first process on node X (and used as described above for detecting and notifying monitoring processes of changes in the status of such first process); and locks Lock.X₂.0 and Lock.X₂.1 may be associated with a second process on node X (and used as described above for detecting and notifying monitoring processes of changes in the status of such second process).

In view of the above, various embodiments of an improved technique that uses a cluster's DLM for managing detection and notification of status changes in cluster processes are provided. Again, the scope of such technique is not limited to the specific example DLM described herein, but instead any DLM implementation now known or later developed that provides notification capabilities, such as completion and blocking notifications, may be used. Further, the scope of the technique is not limited to the specific examples provided herein, but rather various other implementations that leverage a cluster's DLM for managing detection and notification of status changes in cluster processes may be used.

The various embodiments of a DLM and use thereof described above may be implemented via computer-executable software code. The executable software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information.

### APPENDIX A

In general, the TruCluster Server's DLM provides functions that facilitate cooperating processes in a cluster to synchronize access to a shared resource, such as a raw disk device, a file, or a program. For the DLM to effectively synchronize access to a shared resource, all processes in the cluster that share the resource use DLM functions to control access to the resource. DLM functions enable callers to perform such operations as: a) request a new lock on a resource, b) release a lock or group of locks, c) convert the mode of an existing lock, d) cancel a lock conversion request, e) wait for a lock request to be granted, or continue operation and be notified asynchronously of the request's completion, and f) receive asynchronous notification when a lock granted to the caller is blocking another lock request. Table 1 lists various functions provided in the TruCluster Server's DLM.

TABLE 1
Distributed Lock Manager Functions

| Function | Description |
|---|---|
| dlm_cancel | Cancels a lock conversion request |
| dlm_cvt | Synchronously converts an existing lock to a |
| | new mode |
| dlm_detach | Detaches a process from all namespaces |
| dlm_get_lkinfo | Obtains information about a lock request |
| | associated with a given process |
| dlm_get_rsbinfo | Obtains locking information about resources |
| | managed by the DLM |
| dlm_glc_attach | Attaches a process to an existing process lock |
| | group container |
| dlm_glc_create | Creates a group lock container |
| dlm_glc_destroy | Destroys a group lock container |
| dlm_glc_detach | Detaches from a process lock group |
| dlm_lock | Synchronously requests a lock on a named |
| | resource |
| dlm_locktp | Synchronously requests a lock on a named |
| | resource, using group locks or transaction IDs |
| dlm_notify | Requests delivery of outstanding completion |
| | and blocking notifications |
| dlm_nsjoin | Connects the process to the specified |
| | namespace |
| dlm_nsleave | Disconnects the process from the specified |
| | namespace |
| dlm_perrno | Prints the message text associated with a given |
| | DLM message ID |
| dlm_perror | Prints the message text associated with a given |
| | DLM message ID, plus a caller-specified |
| | message string |
| dlm_quecvt | Asynchronously converts an existing lock to a |
| | new mode |
| dlm_quelock | Asynchronously requests a lock on a named |
| | resource |
| dlm_quelocktp | Asynchronously requests a lock on a named |
| | resource, using group locks or transaction Ids |
| dlm_rd_attach | Attaches a process or process lock group to a |
| | recovery domain |
| dlm_rd_collect | Initiates the recovery procedure for a specified |
| | recovery domain by collecting those locks on |
| | resources in the domain that have invalid lock |
| | value blocks |
| dlm_rd_detach | Detaches a process or process lock group from |
| | a recovery domain |
| dlm_rd_validate | Completes the recovery procedure for a |
| | specified recovery domain by validating the |
| | resources in the specified recovery domain |
| | collection |
| dlm_set_signal | Specifies the signal to be used for completion |
| | and blocking notifications |
| dlm_sperrno | Obtains the character string associated with a |
| | given DLM message ID and stores it in a |
| | variable |
| dlm_unlock | Releases a lock |

It will be recognized from the example embodiments described herein that many of the above functions of a DLM are unnecessary for using the DLM to provide notification of status changes in a monitored cluster process. Accordingly, various embodiments of a DLM utilized may not include all of the above functions and/or may include other functions in addition to or instead of the above example functions of the TruCluster DLM.

The TruCluster DLM itself does not ensure proper access to a resource. Rather, the processes that are accessing a resource agree to access the resource cooperatively, use DLM functions when doing so, and respect the rules for using the lock manager. A resource can be any entity in a cluster (for example, a file, a data structure, a raw disk device, a database, or an executable program). When two or more processes access the same resource concurrently, they must often synchronize their access to the resource to obtain correct results. The lock management functions allow processes to associate a name or binary data with a resource and to synchronize access to that resource. Without synchronization, if one process is reading the resource while another is writing new data, the writer can quickly invalidate anything that is being read by the reader.

From the viewpoint of the example TruCluster DLM, a resource is created when a process (or a process on behalf of a DLM process group) first requests a lock on the resource's name. At that point, the DLM creates the structure that contains, among other things, the resource's lock queues and its lock value block. As long as at least one process owns a lock on the resource, the resource continues to exist. After the last lock on the resource is dequeued, the DLM can delete the resource. Normally, a lock is dequeued by a call to the dlm_unlock function, but a lock (and potentially a resource as well) can be freed abnormally if the process exits unexpectedly.

To use the example TruCluster DLM functions, a process requests access to a resource (request a lock) using the dlm_lock, dlm_locktp, dlm_quelock, or dlm_quelocktp function. The request specifies the following parameters:
A namespace handle that is obtained from a prior call to the dlm_nsjoin function.
The resource name that represents the resource.
The length of the resource name.
The identification of the lock's parent.
The address of a location to which the DLM returns a lock ID—The dlm_lock, dlm_locktp, dlm_quelock, and dlm_quelocktp functions return a lock ID when the request has been accepted.
A lock request mode—The DLM functions compare the lock mode of the newly requested lock to the lock modes of other locks with the same resource name.

In the TruCluster DLM, new locks are granted immediately in the following instances:
If no other process has a lock on the resource.
If another process has a lock on the resource, the mode of the new request is compatible with the existing lock, and no locks are waiting in the CONVERTING or WAITING queue. Lock mode compatibility is discussed further below.

In the TruCluster DLM, new locks are not granted in the following instance:
If another process already has a lock on the resource and the mode of the new request is not compatible with the lock mode of the existing lock, the new request is placed in a first-in first-out (FIFO) queue, where the lock waits until the resource's currently granted lock mode (resource group grant mode) becomes compatible with the lock request. Processes can also use the dlm_cvt and dlm_quecvt functions to change the lock mode of a lock. This is called a lock conversion.

As shown further in Table 2 below, six lock modes are provided in the example TruCluster DLM. The mode of a lock determines whether or not the resource can be shared with other lock requests.

TABLE 2
Lock Modes of the TruCluster DLM

| Lock Mode | Description |
|---|---|
| Null (DLM_NLMODE) | Grants no access to the resource; the Null |
| | mode is used as a placeholder for future lock |
| | conversions, or as a means of preserving a |
| | resource and its context when no other locks |
| | on it exist. |
| Concurrent Read | Grants read access to the resource and allows it |
| (DLM_CRMODE) | to be shared with other readers and writers. |
| | The Concurrent Read mode is generally used |
| | when additional locking is being performed at |
| | a finer granularity with sublocks, or to read |
| | data from a resource in an unprotected fashion |
| | (that is, while allowing simultaneous writes to |
| | the resource). |
| Concurrent Write | Grants write access to the resource and allows |
| (DLM_CWMODE) | it to be shared with other writers. The |
| | Concurrent Write mode is typically used to |
| | perform additional locking at a finer |
| | granularity, or to write in an unprotected |
| | fashion. |
| Protected Read | Grants read access to the resource and allows it |
| (DLM_PRMODE) | to be shared with other readers. No writers are |
| | allowed access to the resource. This is the |
| | traditional share lock. |
| Protected Write | Grants write access to the resource and allows |
| (DLM_PWMODE) | it to be shared with Concurrent Read mode |
| | readers. No other writers are allowed access to |
| | the resource. This is the traditional update |
| | lock. |
| Exclusive | Grants write access to the resource and |
| (DLM_EXMODE) | prevents it from being shared with any other |
| | readers or writers. This is the traditional |
| | Exclusive lock. |

Locks that allow the process to share a resource are called low-level locks; locks that allow the process almost exclusive access to a resource are called high-level locks. Null and Concurrent Read mode locks are considered low-level locks; Protected Write and Exclusive mode locks are considered high-level locks. The lock modes from lowest to highest level access modes are as follows:
1. Null (NL)
2. Concurrent Read (CR)
3. Concurrent Write (CW) and Protected Read (PR)
4. Protected Write (PW)
5. Exclusive (EX)

The Concurrent Write (CW) and Protected Read (PR) modes are considered to be of equal level. Locks that can be shared with other granted locks on a resource (that is, the resource's group grant mode) are said to have compatible lock modes. Higher-level lock modes are less compatible with other lock modes than are lower-level lock modes. Table 3 lists the compatibility of the lock modes of the TruCluster DLM.

TABLE 3
Compatibility of Lock Modes of TruCluster DLM

| | | Concurrent | Concurrent | Protected | Protected | Exclusive |
|---|---|---|---|---|---|---|
| | Null (NL) | Read (CR) | Write (CW) | Read (PR) | Write (PW) | (EX) |
| Null (NL) | Yes | Yes | Yes | Yes | Yes | Yes |
| Concurrent | Yes | Yes | Yes | Yes | Yes | No |
| Read (CR) | | | | | | |
| Concurrent | Yes | Yes | Yes | No | No | No |
| Write (CW) | | | | | | |
| Protected | Yes | Yes | No | Yes | No | No |
| Read (PR) | | | | | | |
| Protected | Yes | Yes | No | No | No | No |
| Write (PW) | | | | | | |
| Exclusive | Yes | No | No | No | No | No |
| (EX) | | | | | | |

In the example TruCluster DLM, a lock on a resource can be in one of the following three states:
GRANTED—The lock request has been granted.
CONVERTING—The lock is granted at one mode and a convert request is waiting to be granted at a mode that is compatible with the current resource group grant mode.
WAITING—The new lock request is waiting to be granted.

In the TruCluster DLM, a queue is associated with each of the three states. When a new lock is requested on an existing resource, the DLM determines if any other locks are waiting in either the CONVERTING or WAITING queues, as follows:
If other locks are waiting in either queue, the new lock request is placed at the end of the WAITING queue, except if the requested lock is a Null mode lock, in which case it is granted immediately.
If both the CONVERTING and WAITING queues are empty, the lock manager determines whether the new lock is compatible with the other granted locks. If the lock request is compatible, the lock is granted. If the lock request is not compatible, it is placed on the WAITING queue.

Lock conversions allow processes to change the mode of locks. For example, a process can maintain a low-level lock on a resource until it decides to limit access to the resource by requesting a lock conversion.

A lock request (or conversion request) may complete asynchronous to the request. In the TruCluster DLM, the dlm_lock, dlm_locktp, and dlm_cvt functions complete when the lock request has been granted or has failed, as indicated by the return status value. After a request is queued, the calling process cannot access the resource until the request is granted. Calls to the dlm_quelock, dlm_quelocktp, and dlm_quecvt functions must specify the address of a completion routine. The completion routine runs when the lock request is successful or unsuccessful. The DLM passes to the completion routines status information that indicates the success or failure of the lock request.

The TruCluster DLM provides a mechanism that allows processes to determine whether a lock request is granted synchronously; that is, if the lock is not placed on the CONVERTING or WAITING queue. By avoiding the overhead of signal delivery and the resulting execution of a completion routine, an application can use this feature to improve performance in situations where most locks are granted synchronously (as is normally the case). An application can also use this feature to test for the absence of a conflicting lock when the request is processed.

Blocking notifications are also provided in the TruCluster DLM. In some applications that use the DLM functions, a process must know whether it is preventing another process from locking a resource. The DLM informs processes of this by using blocking notifications. To enable blocking notifications, the blkrtn parameter of the lock request contains the address of a blocking notification routine. When the lock prevents another lock from being granted, a blocking notification is delivered and the blocking notification routine is executed. Thus, blocking notifications may be used to notify processes with granted locks that another process with an incompatible lock mode has been queued to access the same resource.

What is claimed is:

1. A method comprising:
implementing a distributed lock manager (DLM) within a cluster; and
using locks of the DLM to manage notification to at least one monitoring cluster process of a change in status of at least one monitored cluster process.

2. The method of claim 1 wherein said using locks of the DLM to manage notification to at least one monitoring cluster process of a change in status of at least one monitored cluster process comprises:
using locks of the DLM to manage notification to said at least one monitoring cluster process of a change in status of at least one node of said cluster.

3. The method of claim 1 wherein said using locks of the DLM to manage notification to at least one monitoring cluster process of a change in status of at least one monitored cluster process comprises:
using locks of the DLM to manage notification to said at least one monitoring cluster process of a change in status of at least one process executing on at least one node of said cluster.

4. The method of claim 1 wherein said using locks of the DLM to manage notification to at least one monitoring cluster process of a change in status of at least one monitored cluster process comprises:
using said locks to manage notification to said at least one monitoring cluster process of a birth of a new node in the cluster.

5. The method of claim 1 wherein said using locks of the DLM to manage notification to at least one monitoring cluster process of a change in status of at least one monitored cluster process comprises:
using said locks to manage notification to said at least one monitoring cluster process of a death of a node in the cluster.

6. The method of claim 1 wherein said using locks of the DLM to manage notification to at least one monitoring cluster process of a change in status of at least one monitored cluster process comprises:
using said locks to manage notification to said at least one monitoring cluster process of a birth of a new process on a node in the cluster.

7. The method of claim 1 wherein said using locks of the DLM to manage notification to at least one monitoring cluster process of a change in status of at least one monitored cluster process comprises:
using said locks to manage notification to said at least one monitoring cluster process of a death of a monitored process on a node in the cluster.

8. The method of claim 1 further comprising:
monitoring said at least one monitoring cluster process by at least one other monitoring cluster process of said cluster using said DLM.

9. The method of claim 1 further comprising:
said cluster also using said DLM for synchronizing access of nodes of the cluster to shared resources of said cluster.

10. The method of claim 1 wherein said using locks of the DLM to manage notification to at least one monitoring cluster process of a change in status of at least one monitored cluster process comprises:
using blocking notifications of the DLM for notifying said at least one monitoring cluster process of said change in status of said at least one monitored cluster process.

11. The method of claim 1 wherein said using locks of the DLM to manage notification to at least one monitoring cluster process of a change in status of at least one monitored cluster process comprises:
using completion notifications of the DLM for notifying said at least one monitoring cluster process of said change in status of said at least one monitored cluster process.

12. The method of claim 1 wherein said using locks of the DLM to manage notification to at least one monitoring cluster process of a change in status of at least one monitored cluster process comprises:
said at least one monitoring cluster process requesting a first lock for a said at least one monitored cluster process, where said requested first lock is unable to complete as long as said change in status of said at least one monitored cluster process does not occur.

13. The method of claim 12 wherein said using locks of the DLM to manage notification to at least one monitoring cluster process of a change in status of at least one monitored cluster process comprises:
said at least one monitoring cluster process requesting completion notification from the DLM to notify said at least one monitoring cluster process of completion of the requested first lock for said at least one monitored cluster process.

14. The method of claim 12 wherein said at least one monitoring cluster process requesting a first lock comprises:
requesting said first lock that is incompatible with a lock set by the at least one monitored cluster process, wherein said lock set by the at least one monitored cluster process is maintained as long as said change in status of said at least one monitored cluster process does not occur.

15. The method of claim 12 wherein said at least one monitoring cluster process requesting a first lock for a said at least one monitored cluster process, where said requested first lock is unable to complete as long as said change in status of said at least one monitored cluster process does not occur comprises:
said at least one monitoring cluster process requesting said first lock for a said at least one monitored cluster process, where said requested first lock is unable to complete as long as death of said at least one monitored cluster process does not occur.

16. The method of claim 1 wherein said using locks of the DLM to manage notification to at least one monitoring cluster process of a change in status of at least one monitored cluster process comprises:
said at least one monitoring cluster process requesting blocking notification from the DLM to notify said at least one monitoring cluster process of a particular lock blocking a pending lock request for said at least one monitored cluster process; and
wherein upon said change in status of said at least one monitored cluster process occurring, said at least one monitored cluster process requesting a lock that is blocked by said particular lock.

17. The method of claim 16 wherein said change in status of said at least one monitored cluster process upon which said at least one monitored cluster process requests a lock that is blocked by said particular lock is birth of said at least one monitored cluster process within said cluster.

18. The method of claim 1 wherein said using locks of the DLM to manage notification to at least one monitoring cluster process of a change in status of at least one monitored cluster process comprises:
for each of the at least one monitored cluster process, associating two locks with the monitored cluster process, where state of a first one of the two locks is used for managing notification of death of the monitored cluster process in the cluster and state of a second one of the two locks is used for managing notification of birth of the monitored cluster process.

19. A method comprising:
implementing a distributed lock manager (DLM) within a cluster, wherein the DLM provides locking facilities usable by cluster members to lock resources; and
using locking facilities of the DLM to implement a transparent state machine for notifying cluster members of a status change of at least one process within the cluster.

20. The method of claim 19 further comprising:
associating at least two locks with said at least one process to be managed.

21. The method of claim 20 wherein said using locking facilities of the DLM to implement a transparent state machine for notifying cluster members of a status change of at least one process within the cluster comprises:
using a first of said at least two locks for notifying cluster members of a death in said cluster of said at least one process associated with said at least two locks; and
using a second of said at least two locks for notifying cluster members of a birth of said at least one process associated with said at least two locks.

22. The method of claim 19 further comprising:
selectively setting locks for each of said at least one process to a state with a registered call back notification for attempted change to the state.

23. The method of claim 19 wherein said using locking facilities of the DLM to implement a transparent state machine for notifying cluster members of a status change of said at least one process comprises:
said at least one cluster member requesting blocking notification for a lock associated with said at least one process;
upon said at least one process being birthed within the cluster, said at least one process requesting to set said lock associated with said at least one process to a state that is blocked by said first state, wherein blocking notification is provided to the at least one cluster member.

24. The method of claim 19 further comprising:
using blocking notification and completion notification for notifying said cluster members of said state change.

25. The method of claim 24 wherein said blocking notification effectively notifies said at least one cluster member of the birth of said at least one process within said cluster.

26. The method of claim 19 wherein said using locking facilities of the DLM to implement a transparent state machine for notifying cluster members of a status change of said at least one process comprises:
at least one cluster member requesting to change the state of a lock to a second state that is blocked by a first state;
said at least one cluster member requesting completion notification for said requested state change; and
upon death of said at least one process, said requested state change completing to change said lock to said second state, wherein completion notification is provided to the at least one cluster member.

27. The method of claim 26 further comprising:
said completion notification effectively notifying said at least one cluster member of the death of said at least one process within said cluster.

28. The method of claim 19 further comprising:
said cluster members using said locking facilities of said DLM to synchronize access to shared resources of the cluster.

29. The method of claim 19 wherein said notifying cluster members of a status change of at least one process within the cluster comprises:
notifying cluster members of a status change of a node of said cluster.

30. A method comprising:
implementing a distributed lock manager (DLM) within a cluster for synchronizing access of cluster processes to shared resources; and
using said DLM for notifying at least one monitoring cluster process of a status change in a monitored cluster process.

31. The method of claim 30 wherein said notifying at least one monitoring cluster process of a status change in a monitored cluster process comprises:
notifying at least one monitoring cluster process of a status change in a node of said cluster.

32. The method of claim 30 wherein said notifying at least one monitoring cluster process of a status change in a monitored cluster process comprises:
notifying at least one monitoring cluster process of a status change in a process executing on a node of said cluster.

33. The method of claim 30 wherein said using said DLM for notifying at least one monitoring cluster process of a status change in a monitored cluster process comprises:
using said DLM for notifying said at least one monitoring cluster process of birth of said monitored cluster process in the cluster.

34. The method of claim 30 wherein said using said DLM for notifying at least one monitoring cluster process of a status change in a monitored cluster process comprises:
using said DLM for notifying said at least one monitoring cluster process of death of said monitored cluster process.

35. The method of claim 30 further comprising:
monitoring said at least one monitoring cluster process by at least one other monitoring cluster process of said cluster using said DLM.

36. The method of claim 30 wherein said using said DLM for notifying at least one monitoring cluster process of a status change in a monitored cluster process comprises:
using blocking notifications of the DLM for notifying said at least one monitoring cluster process of said status change in said monitored cluster process.

37. The method of claim 30 wherein said using said DLM for notifying at least one monitoring cluster process of a status change in a monitored cluster process comprises:
using completion notifications of the DLM for notifying said at least one monitoring cluster process of said status change in said monitored cluster process.

38. The method of claim 30 wherein said using said DLM for notifying at least one monitoring cluster process of a status change in a monitored cluster process comprises:
said at least one monitoring cluster process requesting a first lock for a said monitored cluster process, where said requested first lock is unable to complete as long as said change in status of said monitored cluster process does not occur.

39. The method of claim 30 wherein said using said DLM for notifying at least one monitoring cluster process of a status change in a monitored cluster process comprises:
said at least one monitoring cluster process requesting completion notification from the DLM to notify said at least one monitoring cluster process of completion of a requested first lock for said monitored cluster process.

40. The method of claim 38 wherein said requesting a first lock for a said monitored cluster process comprises:
requesting a first lock that is incompatible with a lock previously set by the monitored cluster process, wherein said lock previously set by the monitored cluster process is maintained as long as said change in status of said monitored cluster process does not occur.

41. The method of claim 38 wherein said at least one monitoring cluster process requesting a first lock for a said monitored cluster process, where said requested first lock is unable to complete as long as said change in status of said monitored cluster process does not occur comprises:
said at least one monitoring cluster process requesting a first lock for a said monitored cluster process, where said requested first lock is unable to complete as long as death of said monitored cluster process does not occur.

42. A system comprising:
a cluster having a plurality of processor-based devices as members; and
a distributed lock manager (DLM) implemented within said cluster, wherein said members use said DLM at least in part for receiving notification of a status change in at least one monitored cluster process.

43. The system of claim 42 further comprising:
at least one resource shared by said members; and
wherein said DLM is further used by said members for synchronizing access to said at least one shared resource.

44. The system of claim 42 wherein said members use said DLM at least in part for receiving notification of at least one of the following status changes in said cluster:
birth of said at least one monitored cluster process in said cluster, and death of said at least one monitored cluster process.

45. The system of claim 42 comprising:
at least one monitoring cluster member that requests a first lock state for a lock associated with a monitored cluster process, wherein said lock associated with a monitored cluster process is not permitted to be set to said first lock state until said status change in said monitored cluster process occurs.

46. The system of claim 45 wherein said DLM provides completion notification to said at least one monitoring cluster member upon said lock associated with said monitored cluster process being set to said first lock state.

47. The system of claim 45 wherein said status change in said monitored cluster process is death of said monitored cluster process.

48. The system of claim 42 comprising:
at least one monitoring cluster member that sets a blocking lock state for a lock associated with a monitored cluster process, wherein upon said status change in said monitored cluster process occurring, said monitored cluster process requesting a lock state for the lock that is blocked by said blocking lock state.

49. The system of claim 48 wherein said DLM provides blocking notification to said at least one monitoring cluster member upon said set blocking lock blocking a requested lock state.

50. The system of claim 48 wherein said status change in said monitored cluster process is birth of said monitored cluster process in said cluster.

51. A clustered computer system comprising:
distributed locking means for providing at least one locking means associated with at least one monitored process within the clustered computer system; and
said at least one locking means enables a monitoring process of the clustered computer system to request a state change in a lock associated with said at least one monitored process and request notification of completion of such state change, wherein the requested state change is not permitted by the distributed locking means to complete as long as said at least one monitored process is alive in the clustered computer system.

52. The clustered computer system of claim 51 wherein upon being birthed in said clustered computer system, said at least one monitored process sets said locking means associated with said at least one monitored process to a first state that blocks said requested state change requested by the monitoring process from completing.

53. The clustered computer system of claim 52 wherein said distributed locking means permits said locking means to maintain the first state set by the at least one monitored process as long as the at least one monitored process is alive in the clustered computer system.

54. The clustered computer system of claim 52 wherein said monitoring process requests the requested state change after said at least one-monitored process sets said locking means to said first state.

55. The clustered computer system of claim 52 wherein upon said state change requested by the monitoring process completing, said distributed locking means notifies said monitoring process of such completion.

56. The clustered computer system of claim 51 further comprising:
said at least one locking means further enables said monitoring process of the clustered computer system to set a lock associated with at least one unbirthed monitored process that has not been birthed in the clustered computer system and request notification of said set lock blocking a requested state change to the lock associated with said at least one unbirthed monitored process.

57. The clustered computer system of claim 56 wherein upon an unbirthed process being birthed in said clustered computer system, said birthed monitored process requests a locking means associated with said at least one unbirthed monitored process be set to a state that is blocked by said set lock.

58. The clustered computer system of claim 57 wherein upon said state change requested by the birthed monitored process being blocked, said distributed locking means notifies said monitoring process of such blocked request.

59. A method comprising:
associating, with a monitored cluster process, at least one lock of a distributed lock manager (DLM) implemented in a cluster;
said monitored cluster process setting a first associated lock to a first mode;
at least one monitoring cluster process requesting to change said first associated lock to a second mode that is incompatible to said first mode; and
said DLM providing notification to said at least one monitoring cluster process upon said requested change of said first associated lock to said second mode completing.

60. The method of claim 59 further comprising:
said at least one monitoring cluster process requesting completion notification from said DLM.

61. The method of claim 59 further comprising:
maintaining said first mode for said first associated lock as long as said monitored cluster process is alive in said cluster.

62. The method of claim 59 wherein said requested change in said first associated lock to said second mode is not blocked as long as said cluster process is alive in said cluster.

63. The method of claim 59 further comprising:
associating, with an unbirthed monitored cluster process, at least one lock of said DLM;
said at least one monitoring cluster process setting a second associated lock of said unbirthed monitored cluster process to a blocking mode;
upon being birthed in said cluster, said unbirthed monitored cluster process requesting to change said second associated lock to a mode that is blocked by said blocking mode; and
said DLM providing notification to said at least one monitoring cluster process upon said set blocking mode of said second associated lock blocking said requested change to said second associated lock from completing.

64. A method comprising:
associating at least one lock of a distributed lock manager (DLM) implemented in a cluster with an offline monitored cluster process;
at least one monitoring cluster process setting a first lock associated with said offline monitored cluster process to a first mode; and
when coming online within said cluster, said monitored cluster process requesting to set said first lock to a second mode that is blocked by said first mode, which triggers blocking notification from said DLM to said at least one monitoring cluster process.

65. The method of claim 64 further comprising:
said at least one monitoring cluster process requesting that said DLM provide blocking notification for said set first lock.

66. The method of claim 64 further comprising:
upon coming online within said cluster, the monitored cluster process sets a second lock associated with said monitored cluster process to a first mode;
said at least one monitoring cluster process requesting to change said second lock to a second mode, wherein said first mode blocks said requested change to said second mode from completing; and
when said monitored cluster process goes offline, said requested change in said second lock to said second mode is permitted to complete, which triggers completion notification from said DLM to said at least one monitoring cluster process.

67. The method of claim 66 further comprising:
said at least one monitoring cluster process requesting that said DLM provide completion notification for said requested change to said second lock.

68. Computer-executable software code stored to computer-readable medium, said computer-executable software code comprising:
code for associating at least two locks of a distributed lock manager (DLM) implemented in a cluster with a cluster process to be monitored;
code for enabling at least one monitoring cluster process to use a first of said at least two locks for detecting birth of said monitored cluster process within said cluster; and
code for enabling at least one monitoring cluster process to use a second of said at least two locks for detecting death of said monitored cluster process.

69. The computer-executable software code of claim 68 wherein said code for enabling said at least one monitoring cluster process to use a first of said at least two locks for detecting birth of said monitored cluster process within said cluster comprises:
code for enabling said at least one monitoring cluster process to set said first of said at least two locks to a first mode; and
code for enabling said monitored cluster process, when being birthed within said cluster, to request to set said first of said at least two locks to a second mode that is blocked by said first mode, which triggers blocking notification from said DLM to said at least one monitoring cluster process.

70. The computer-executable software code of claim 69 wherein said blocking notification notifies said at least one monitoring cluster process of the birth of said monitored cluster process within the cluster.

71. The computer-executable software code of claim 68 wherein said code for enabling said at least one monitoring cluster process to use a second of said at least two locks for detecting death of said monitored cluster process comprises:
code for enabling the monitored cluster process to set said second of said at least two locks associated with said monitored cluster process to a first mode;
code for enabling said at least one monitoring cluster process to request to change said second of said at least two locks to a second mode, wherein said first mode blocks said requested change to said second mode from completing; and
upon death of said monitored cluster process, said requested change in said second of said at least two locks to said second mode is permitted to complete, which triggers completion notification from said DLM to said at least one monitoring cluster process.

72. The computer-executable software code of claim 71 wherein said completion notification notifies said at least one monitoring cluster process of the death of said monitored cluster process.
